(19) United States
(12) Patent Application Publication
(10) Pub. No.: US 2016/0182536 A1
(43) Pub. Date: Jun. 23, 2016

(54) ADAPTING USER TERMINAL APPLICATION OPERATION RESPONSIVE TO MEASURED USER BEHAVIOR

(71) Applicant: CA, INC., New York, NY (US)

(72) Inventor: Jonathan Lindo, Emerald Hills, CA (US)

(73) Assignee: CA, INC., New York, NY (US)

(21) Appl. No.: 14/577,073

(22) Filed: Dec. 19, 2014

(51) Int. Cl. H04L 29/06; H04L 12/26; H04L 29/08

(52) U.S. Cl. CPC H04L 63/1408; H04L 67/306; H04L 43/16

(57) ABSTRACT

User profile information is generated which characterizes measured user's interaction with an application program that is encapsulated by the computer readable program code and processed by a processor of user terminal. Operation of the application program is adapted based on the user profile information.

### BACKGROUND

The present disclosure relates to computing systems, and, in particular, to management of user terminals and/or applications.

Monetizing mobile applications can involve difficult tradeoffs during development. Application sales can be increased by appealing to the diverse interests of a broad user demographics base. However, the frequency and duration with which applications are used heavily depends upon the individualist preferences of the user. Increasing the frequency and duration of application use provides more opportunities for monetization from in-application advertisements and users' application ratings.

When an application is targeted for a broad user base, a developer risks having a large number of initial downloads but then low application utilization and poor user application ratings. Conversely, when an application is targeted for a more focused user base, a developer risks having a small number of initial downloads but then high application utilization and good user application ratings. Neither scenario may allow maximizing monetization opportunities from the mobile application.

### SUMMARY

In some embodiments of the present disclosure, a computer program product includes tangible computer readable storage medium including computer readable program code embodied in the medium that when executed by a processor of a user terminal causes the processor to perform operations including generating user profile information characterizing measured user's interaction with an application program that is encapsulated by the computer readable program code and processed by the processor. Operation of the application program is adapted based-on the user profile information.

Other methods, systems, and/or computer program products according to embodiments of the inventive subject matter will be or become apparent to one with skill in the art upon review of the following drawings and detailed description. It is intended that all such additional methods, systems, and/or computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a system for customizing user terminal application operation responsive to measured user behavior using an instrument encapsulation module which encapsulates the application in accordance with some embodiments of the present disclosure;

FIG. 2 is a combined data flow diagram and flowchart of operations by a user terminal and an application analysis computer for customizing user terminal application operation responsive to measured user behavior using an instrument encapsulation module which encapsulates the application in accordance with some embodiments of the present disclosure;

FIGS. 3-10 are flowcharts of operations that may be performed by a user terminal configured according to some embodiments of the present disclosure;

FIG. 11 is a block diagram of a user terminal configured according to some embodiments of the present disclosure; and

FIG. 12 is a block diagram of an application analysis computer configured according to some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Over a billion Apple IOS user terminals and Android user terminals are presently being used throughout the world. These user terminals connect through data networks (e.g., Internet) to application servers to download application programs for processing. As explained above, application sales can be increased by appealing to the diverse interests of a broad user demographics base. However, the frequency and duration with which applications are used heavily depends upon the individualist preferences of the user. Increasing the frequency and duration of application use provides more opportunities for monetization from in-application advertisements and users' application ratings.

When an application is targeted for a broad user base, a developer risks having a large number of initial downloads but then low application utilization and poor user application ratings. Conversely, when an application is targeted for a more focused user base, a developer risks having a small number of initial downloads but then high application utilization and good user application ratings. Neither scenario may allow maximizing monetization opportunities from the mobile application.

Various embodiments of the present disclosure are directed to providing dynamic adaptation of user terminal application program operations based on how a user is measured using the application program. These embodiments may operate to customize application program operations to encourage increased frequency of use, duration of use, and satisfaction with the mobile application. Information can be generated that characterizes a particular user by how the user is measured using the application program, and this information can be analyzed to control selection of additional features for the same or different application program that can be offered/provided to the particular user and control other operations of the application program.

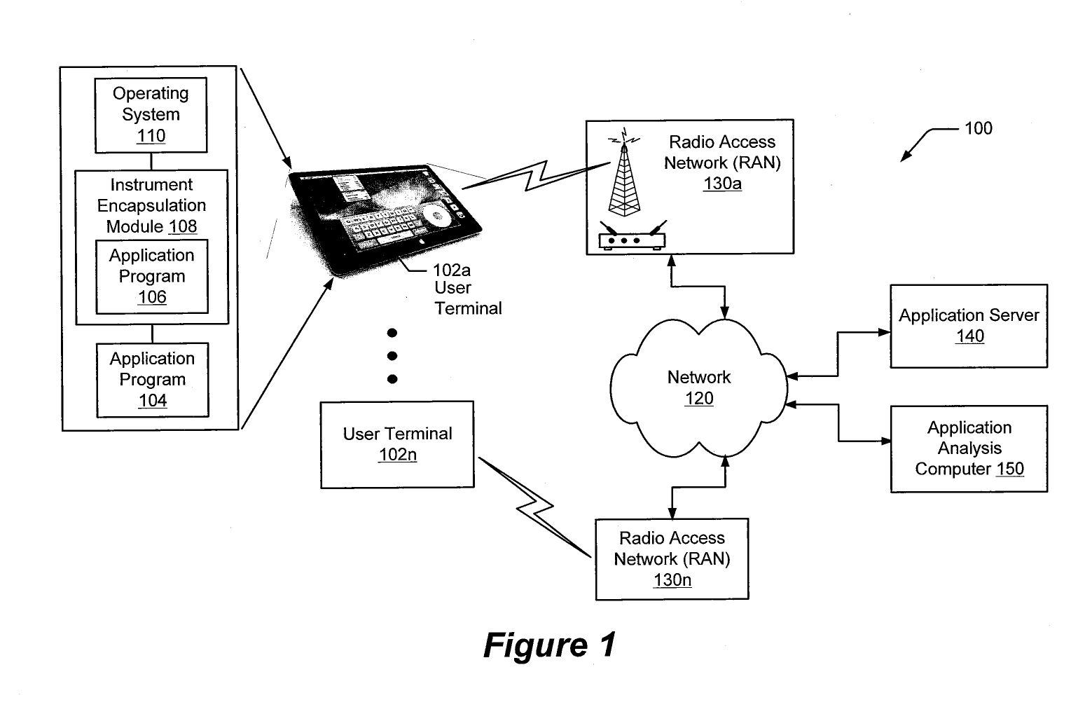

FIG. 1 is a block diagram of a system 100 for customizing application program 106 operation by user terminals 102a-102n responsive to measured user behavior using an instrument encapsulation module 108 which encapsulates the application program 106 in accordance with some embodiments of the present disclosure. The user terminals 102a-102n communicate through wireless (e.g., radio access networks (RAN) 130a-130n) and/or wired network connections via a data network 120 (e.g., Internet) with an application server 140, and may further communicate with an application analysis computer 150. For example, one or more of the user terminals 102a-102n may communicate through the radio access networks 130a-130n using one or more wireless communication protocols that may include, but are not limited to, LTE, WLAN (IEEE 802.11), WiMax, and/or Bluetooth.

The user terminals 102a-102n can download application programs from the application server 140. The application server 140 may, for example, include the Apple application store server (e.g., iTunes) and/or one or more of the Android application store server (e.g., Google Play and/or Amazon Appstore). The application programs can include gaming programs, spreadsheet programs, multimedia programs, word processing programs, database programs, presentation programs, etc.

Although FIG. 1 illustrates a certain number of system components for ease of illustration and explanation, it is to be understood that embodiments of the present disclosure are not limited to the illustrated configuration but instead are intended to encompass any configuration capable of carrying out at least some of the operations described herein.

Each of the user terminals 102a-102n include an instrument encapsulation module 108 that operates to generate user profile information characterizing measured user's interaction with the application program 106 that is encapsulated by the instrument encapsulation module 108 and processed by a processor of the respective user terminals 102a-102n. The instrument encapsulation module 108 may “wrap around” the application program 106 to intercept or otherwise observe application programming interface (API) calls from the application program 106 to other application programs 104 processed by the user terminal 102, an operating system processed by the user terminal 102, and/or other software/hardware resources of the user terminal 102.

As used herein, an “API request” can be any signaling occurring from one to another software application that may be performed using a defined syntax and one or more parameters (e.g., data structure, object classes, and/or variables) to obtain data therefrom and/or to provide data thereto. For example, SOAP and REST service requests can be performed using a defined API library of remote calls or other types of API requests.

The instrument encapsulation module 108 may process the measured user's interaction to generate information that is communicated to the application analysis computer 150 via the data network 120, and/or the instrument encapsulation module 108 may communicate the measured user's interaction to the application analysis computer 150 for processing through an analytics engine residing therein.

Although the application analysis computer 150 has been illustrated as being separate from the application server 140, some or all of the functionality of the application analysis computer 150 may be combined with the application server 140.

The instrument encapsulation module 108 characterizes a user's interaction with the application program 106 by measuring operation of the application program 106 that is encapsulated. The types of operational measurements that can be performed by the instrument encapsulation module 108 for generating user profile information may include any one or more of the following:
1. duration of operational use of the application program 106 by the user;
2. time between instances of application program 106 use;
3. time of day and/or day or week of instances of application program 106 use;
4. control gestures or other inputs provided by a user as input to control application program 106 operation;
5. which features and/or sequences of features of the application program 106 are used;
6. how often features and/or sequences of features of the application program 106 are used;
7. responsiveness of a user to provide an input to control application program 106 operation, such as user input responsiveness to prompts generated by the application program 106;
8. digital voice sample of user via microphone of user terminal 102;
9. digital picture and/or digital video of user via camera of user terminal 102;
10. operational settings selected by the user for operation of the application program 106 and/or changes over time in the user selected operational settings;
11. gaming challenges or levels selected in an instance by the user from among available challenges/levels;
12. number of features or levels of features of the application program 106 accessed or completed by a user;
13. number of unsuccessful attempts by the user to complete a feature of the application program 106 before ceasing playing;
14. events characterizing inefficient or ineffective operational use of the application program 106 (e.g., appearing navigationally lost within an application program user interface, such as within a game environment);
15. operations that occurred proximate in time to when the user shuts-down the application program 106;
16. whether in-application advertisements are present/absent during user's use of a feature of the application program 106 and any perceived affect on user's behavior while using the application program 106 (e.g., changes in user responsiveness to game play, changes in duration of playing, ceasing playing proximate in time to appearance of defined types/sizes/locations of advertisements, etc.);
17. characteristics of in-application advertisements displayed during user's use of a feature of the application program 106 and any perceived affect on user's behavior while using the application program 106 (e.g., changes in user responsiveness to game play, etc.);
18. characteristics of in-application advertisements selected by a user while using the application program 106;
19. characteristics of in-application advertisements selected by a user while using the application program 106;
20. whether the user selects advertisements while using application programs and, if so, what type of application program(s);
21. whether a user typically uses headphones while using the application program 106;
22. volume setting typically set by user while using the application program 106;
23. user selection of additional in-application features (e.g., download/activate);
24. user selection of other application programs (e.g., download/activate) while using the application program 106;
25. identification and/or characterization of the data communications between the application program 106 interfacing and another application program, an operating system 110, and/or to other software/hardware resources of the user terminal; and
26. other application programs active in background while user is using the application program 106.

The instrument encapsulation module 108 may also generate the user profile information based on measurements of one or more of the following:
1. hardware resource utilization (e.g., application program 106 utilization of user terminal processor resources, application program 106 utilization of user terminal memory resources, rate of information displayed by the application program 106 on a display device of the user terminal 102, application program 106 utilization of user terminal 102 network interface resources, etc.);
2. characteristics of the user terminal 102 processing the application program 106 (e.g., display resolution, speaker volume capability, screen refresh rate capability, manufacturer, operating system information, web browser information, etc.);
3. identifier of the user terminal 102 (e.g., network address, phone number, mobile ID, etc.)
4. mobile application information display update rate;
5. communication latency through the data network 120 and/or the radio access network 130 while processing the application program 106;
6. communication latency between the application program 106 and the application program 104;
7. application program 106 preferred and/or present information display update rate;
8. screen shots captured from a user terminal 102 display or sub-window associated with the application program 106;
9. video captured from user terminal 102 display or sub-window associated with the application program 106;
10. geographic region of the user terminal 102 while the application program 106 is being processed;
11. velocity of the user terminal 102 while processing the application program 106; and
12. events indicative of errors or undesirable operation of the application program 106; and
13. occurrence of one or more defined control gestures performed by the user through a user interface of the user terminal 102 to interface with the application program 106 and/or frequency of occurrence of the one or more defined control gestures.

The instrument encapsulation module 108 measures operation of the application program 106 which it encapsulates. The instrument encapsulation module 108 may measure operation of the application program 106 by intercepting and analyzing API calls by the application program 106 to the other application program 104 and/or to the operating system of the user terminal 102.

The instrument encapsulation module 108 analyzes the operational events to characterize the user's behavior and operational use of the mobile application, and responsively trigger adaptation of the mobile application operations. The analysis may include one or more of the following:
1. characterizing a level of expertise or familiarity of the user with the application program 106;
2. persistence of the user to using operational features or solving challenges (e.g., gaming) provided by operation of the application program 106;
3. types of operational features or operational challenges that are desirable and/or undesirable to the user by operation of the application program 106;
4. user's interest in fast paced games vs. slow paced games;
5. user's interest in visually complex display features (e.g., near-field vision issues) available from the application program 106;
6. user's interest in exploring new operational features available from the application program 106;
7. user's interest/tolerance for in-application advertisements while using the application program 106;
8. user's interest for various types of in-application features while using the application program 106;
9. estimation of age, gender, and/or another characteristic of the user based on voice imprint of user via microphone, and prediction of user preferences for using the application program 106 based thereon;
10. estimation the effect on the user's positive perception of the application program 106 by in-application advertisements displayed during user's use of the application program 106;
11. estimating affect on user's ability to operate the application program 106 by in-application advertisements displayed during user's use of the application program 106; and
12. estimation of age, gender, and/or another characteristic of the user based on picture/video of user via camera, and prediction of user preferences for using the application program 106 based thereon.

The instrument encapsulation module 108 contains one or more operation adaptation rules which control adaptation of application program 106 operation based on the user profile information. The instrument encapsulation module 108 may determine when the user profile information satisfies operation adaptation rules and, when satisfied, adapts operation of the application program 106.

In the context of a gaming program, the instrument encapsulation module 108 may use the user profile information to control operation of the application program 106 to:
1. simplify or increase complexity of game play;
2. display larger more easily observable indicia or smaller more ornamental indicia;
3. determine which available application features are offered to or activated for the user within the same mobile application or another application;
4. determine timing for offering/activating application features;
5. determine prices to be offered for activation of the features; and/or
6. determine timing of offering assistance with application program operation.

In this manner an application program can be automatically customized for a particular user based on observations of the user's behavior when using the application program. Such customization may encourage increased frequency of use, duration of use, and satisfaction with application programs processed by user terminals.

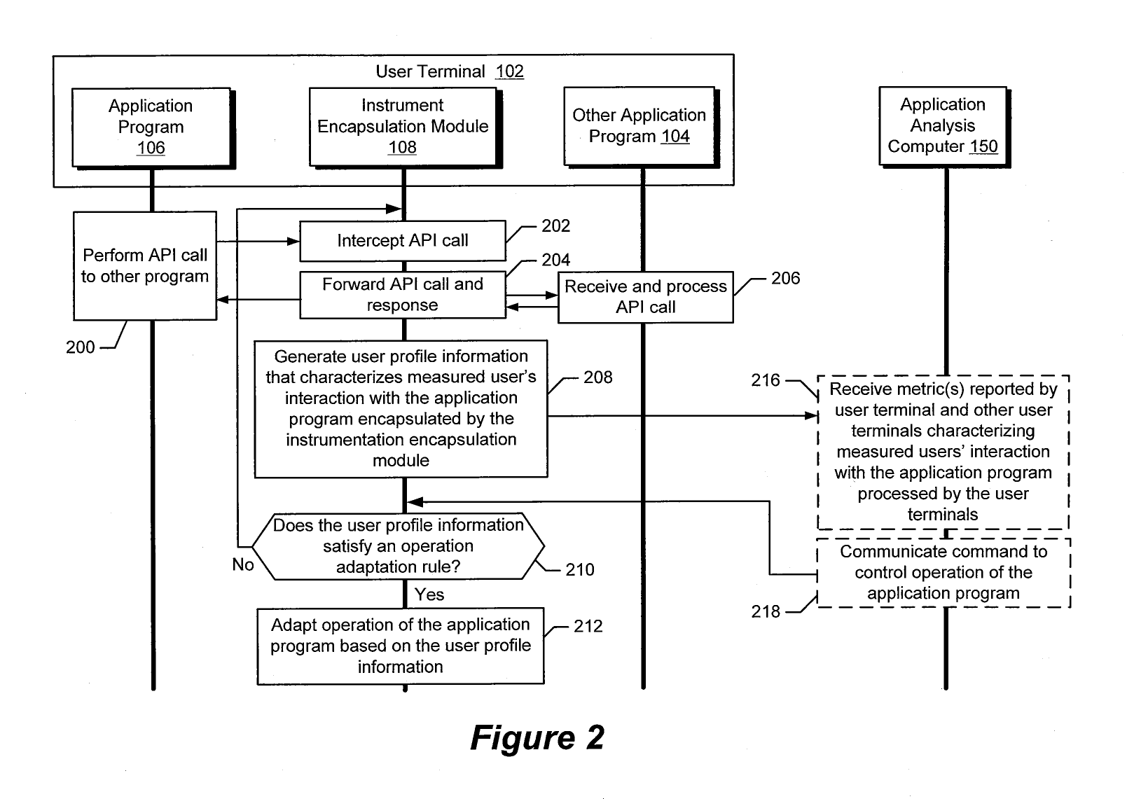

FIG. 2 is a combined data flow diagram and flowchart of operations by the user terminal 102 and the application analysis computer 150 for customizing user terminal application 102 operation responsive to measured user behavior using the instrument encapsulation module 108 which encapsulates the application program 106 in accordance with some embodiments of the present disclosure.

Referring to FIG. 2, the application program 106 performs an API call (block 200) to the other application program 104. The instrument encapsulation module 108 intercepts (block 202) the API call. The instrument encapsulation module 108 forwards (block 204) the API call to the other application program 104, which receives and processes (block 206) the API call. The other application program 104 may communicate a response message which is intercepted and forwarded (block 204) through the instrument encapsulation module 108 to the application program 106.

The instrument encapsulation module 108 generates (block 208) user profile information that characterizes the user's interaction with the application program 106 which is encapsulated by the instrument encapsulation module 108. The instrument encapsulation module 108 determines (block 210) whether the user profile information satisfies an operation adaptation rule. When the operation adaptation rule has not been satisfied the operation can loop back to wait for interception (block 202) of another API call performed by the application program 106. In contrast, when the operation adaptation rule has been satisfied, the instrument encapsulation module 108 adapts (block 212) operation of application program 106 based on the user profile information.

The application analysis computer 150 receives (block 214) the metric reported by the instrument encapsulation module 108 of the user terminal 102 (e.g., user terminal 102a) along with metrics reported by other user terminals (e.g., user terminals 102b-102n). Each of the received metrics indicates a measured operation of an application program that is being processed by the respective user terminals (e.g., user terminals 102a-102n).

In one embodiment, to generate the observe user profile information the instrument encapsulation module 108 may communicate one or more metrics, measured from one or more API calls by the application program 106 based on one or more of the observable operations disclosed herein, to the application analysis computer 150. The application analysis computer 150 receives (block 216) the one or more metrics, and communicates (block 218) a command to control operation of application program 106.

For example, the application analysis computer 150 may generate the command based on comparison of one or more of: 1) the time between instances of application program 106 use to different defined thresholds for different categories of users, 2) comparison of the responsiveness of user at providing inputs responsive to prompts generated during application program 106 operation to different defined thresholds for different categories of users, 3) comparison of a digital voice sample to defined voice characteristics for different categories of users, 4) comparison of a digital picture and/or digital video of user to defined picture characteristics and/or video characteristics for different categories of users, 5) comparison of events characterizing inefficient or ineffective operational use of the application program 106 to events characterizing different categories of users, etc.

The application analysis computer 150 may collect metrics reported from across all of the user terminals 102a-102n reported by instances of the instrument encapsulation modules 108 processed by the terminals 102a-102n. The application analysis computer 150 may analyze patterns among the metrics to characterize the users of each of the user terminals 102a-102n. For example, a user may be characterized based on having an above average number of unsuccessful attempts by the user, compared to users of the other user terminals 102a-102n, to complete a features of the application program 106 before ceasing playing, etc.

When the application analysis computer 150 communicates (block 218) a command to the user terminal 102, the instrument encapsulation module 108 can adapt (block 214) operation of application program 106 based on the command, and may further adapt the operation based on the observe user profile information satisfying the operation adaption rule defined by the instrument encapsulation module 108.

In another related embodiment, the user profile information characterizing measured user's interaction with the application program 106 encapsulated by the instrument encapsulation module 108 is generated based on operations that include obtaining a digital picture of the user from a camera of the user terminal 102. A list of operations performed by the application program 106 responsive to user interaction with the application program 106 is generated. The digital picture and the listing of operations performed by the application program 106 are communicated from the user terminal 102 to the application analysis computer 150 to generate the user profile information that characterizes the user's interaction with the application program 106. Adapting operation of the application program 106 based on the user profile information can include receiving a command from the application analysis computer 150, and selectively enabling and disabling features of the application program 106 based on the command. For example, the age, gender, and/or another characteristic of the user may be estimated based on the digital picture, and operation of the application program 106 can be adapted based on the characteristic.

In another related embodiment, the user profile information characterizing measured user's interaction with the application program 106 encapsulated by the instrument encapsulation module 108 is generated based on operations that include obtaining a digital voice sample of the user from a microphone of the user terminal 102. A list of operations performed by the application program 106 responsive to user interaction with the application program 106 is generated. The digital voice sample and the listing of operations performed by the application program 106 are communicated from the user terminal 102 to the application analysis computer 150 to generate the user profile information that characterizes the user's interaction with the application program 106. Adapting operation of the application program 106 based on the user profile information can include receiving a command from the application analysis computer 150, and selectively enabling and disabling features of the application program 106 based on the command. For example, the age, gender, and/or another characteristic of the user may be estimated based on the digital voice sample, and operation of the application program 106 can be adapted based on the characteristic.

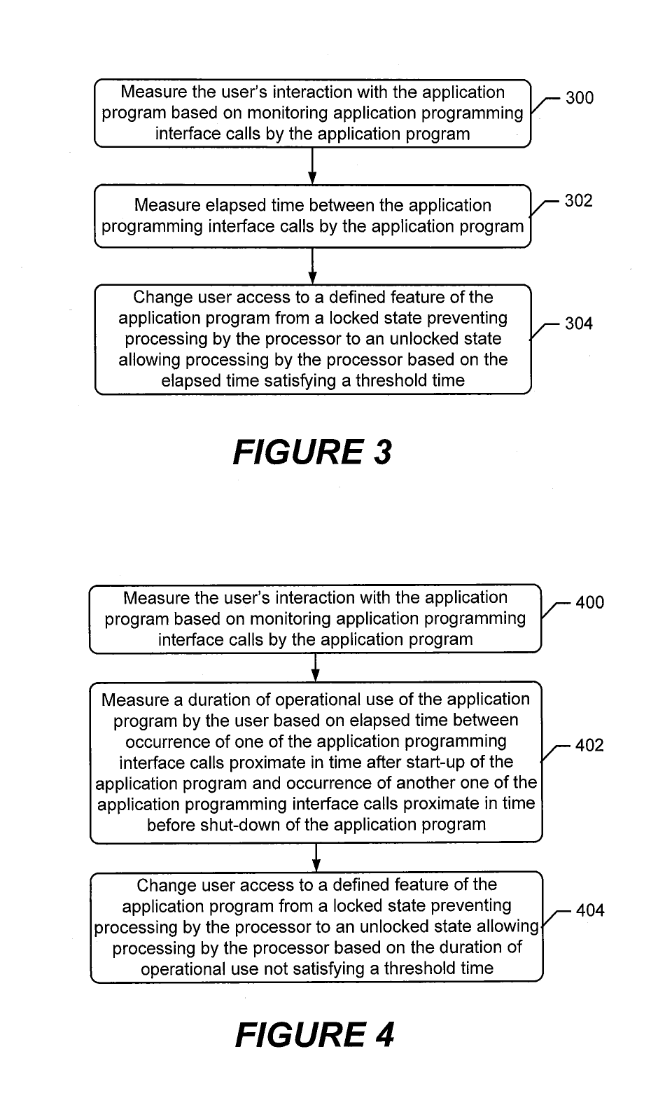

Various further operations can be performed by the user terminal 102 to generate the user profile information and adapt operation of the application program are illustrated in the flowcharts of FIGS. 3-10 according to some embodiments of the present disclosure.

In the embodiment of FIG. 3, the user's interaction with the application program 106 is measured (block 300) based on monitoring application programming interface calls by the application program 106. The elapsed time between the application programming interface calls by the application program is measured (block 302), and user access to a defined feature of the application program is changed (block 304) from a locked state preventing processing by a processor of the user terminal 102 to an unlocked state allowing processing by the processor based on the elapsed time satisfying a threshold time.

In the embodiment of FIG. 4, the user's interaction with the application program 106 is measured (block 400) based on monitoring application programming interface calls by the application program 106. A duration of operational use of the application program 106 by the user is measured (block 402) based on elapsed time between occurrence of one of the application programming interface calls proximate in time after start-up of the application program 106 and occurrence of another one of the application programming interface calls proximate in time before shut-down of the application program 106. User access to a defined feature of the application program is changed (block 404) from a locked state preventing processing by a processor of the user terminal 102 to an unlocked state allowing processing by the processor based on the duration of operational use not satisfying a threshold time.

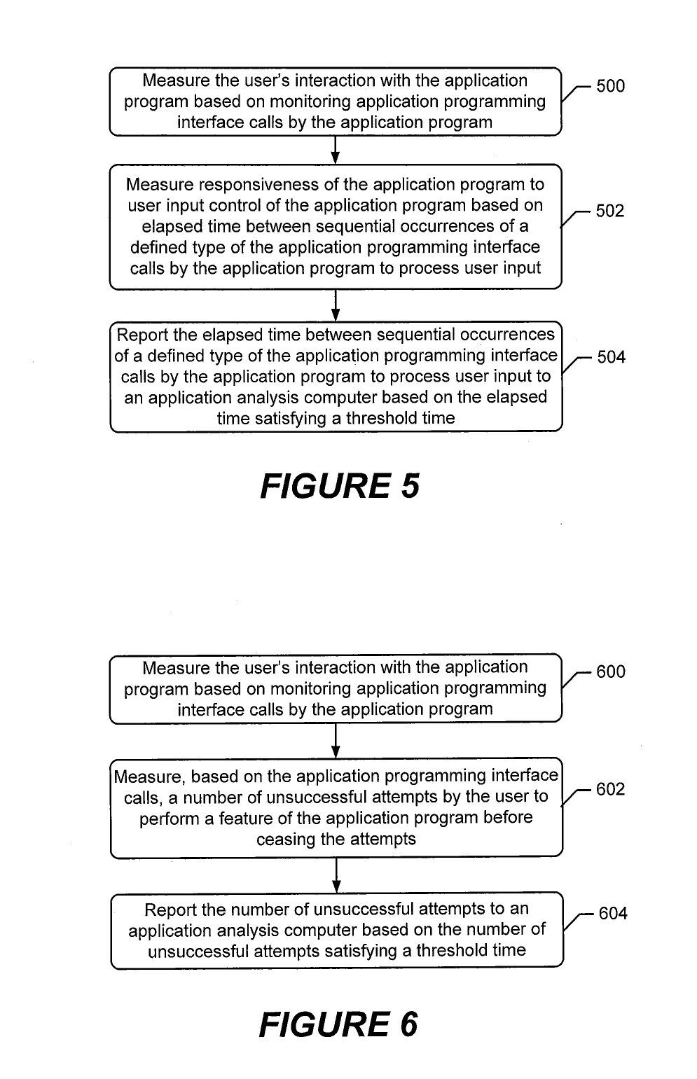

In the embodiment of FIG. 5, the user's interaction with the application program 106 is measured (block 500) based on monitoring application programming interface calls by the application program 106. Responsiveness of the application program 106 to user input control of the application program is measured (block 502) based on elapsed time between sequential occurrences of a defined type of the application programming interface calls by the application program 106 to process user input. The elapsed time between sequential occurrences of a defined type of the application programming interface calls by the application program 106 to process user input is reported (block 504) to the application analysis computer 150 based on the elapsed time satisfying a threshold time.

In the embodiment of FIG. 6, the user's interaction with the application program 106 is measured (block 600) based on monitoring application programming interface calls by the application program 106. A number of unsuccessful attempts by the user to perform a feature of the application program 106 before ceasing the attempts is measured (block 602) based on the application programming interface calls. The number of unsuccessful attempts is reported (604) to the application analysis computer 150 based on the number of unsuccessful attempts satisfying a threshold time.

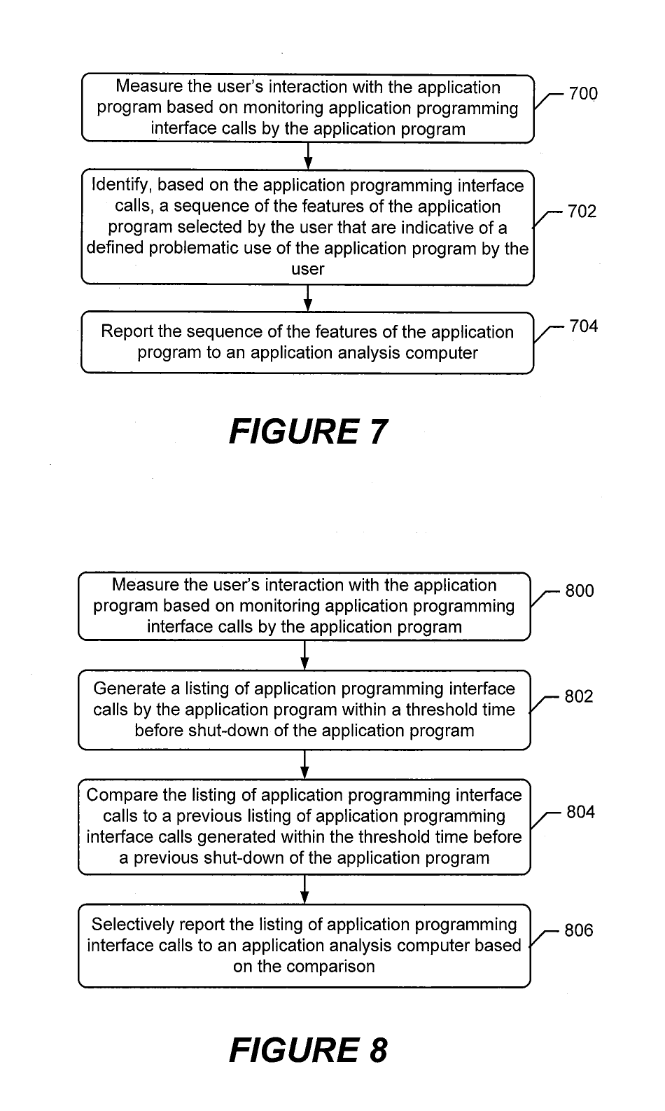

In the embodiment of FIG. 7, the user's interaction with the application program 106 is measured (block 700) based on monitoring application programming interface calls by the application program 106. A sequence of the features of the application program 106 selected by the user that are indicative of a defined problematic use of the application program 106 by the user are identified (block 702) based on the application programming interface calls. The sequence of the features of the application program 106 are reported (block 704) to the application analysis computer 150.

In the embodiment of FIG. 8, the user's interaction with the application program 106 is measured (block 800) based on monitoring application programming interface calls by the application program 106. A listing of application programming interface calls by the application program relating to communication between the application program and another application program executed by the processor of the user terminal is generated (block 802). The listing of application programming interface calls is compared (block 804) to a previous listing of application programming interface calls generated within the threshold time before a previous shut-down of the application program 106. The listing of application programming interface calls is selectively reported (block 806) to the application analysis computer 150 based on the comparing. For example, when the comparison does not satisfy a defined rule the listing is not reported and, in contrast, when the comparison does satisfy a defined rule the listing is reported to the application analysis computer 150.

The listing of application programming interface calls by the application program can be defined to relate to communication between the application program 106 and another application program 104 executed by the processor of the user terminal 102.

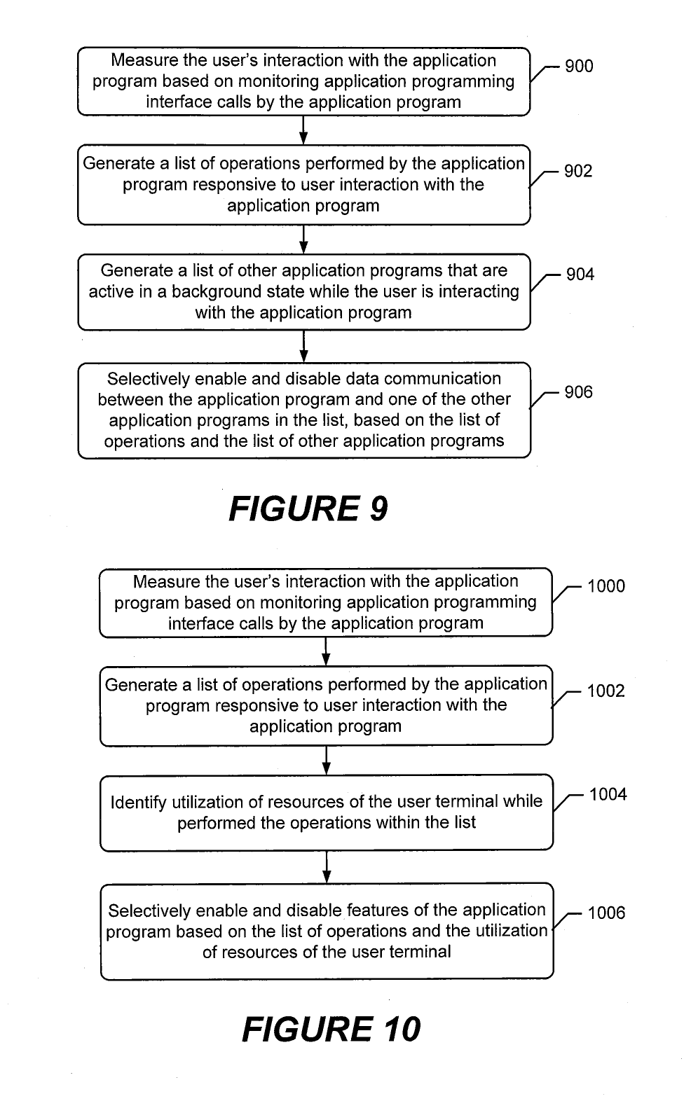

In the embodiment of FIG. 9, the user's interaction with the application program 106 is measured (block 900) based on monitoring application programming interface calls by the application program 106. A list of operations performed by the application program 106 responsive to user interaction with the application program 106 is generated (block 902). A list of other application programs 104 that are active in a background state while the user is interacting with the application program 106 is generated (block 904). Adapting operation of the application program 106 based on the user profile information can include selectively enabling (block 906) and disabling data communication between the application program 106 and one of the other application programs 104 in the list, based on the list of operations and the list of other application programs.

For example, when a comparison of the list of operations and the list of other application programs does not satisfy a defined rule the data communication can be disabled and, in contrast, when the comparison does satisfy a defined rule the data communication can be enabled.

In another related embodiment, the user's interaction with the application program 106 is measured based on monitoring application programming interface calls by the application program 106. A list of operations performed by the application program 106 responsive to user interaction with the application program 106 can be generated. A geographic region in which the user terminal 102 is located can be identified. Adapting operation of the application program 106 based on the user profile information can include selectively enabling and disabling features of the application program 106 based on the list of operations and the geographic region.

In the embodiment of FIG. 10, the user's interaction with the application program 106 is measured (block 1000) based on monitoring application programming interface calls by the application program 106. A list of operations performed by the application program 106 responsive to user interaction with the application program 106 can be generated (block 1002). Utilization of resources of the user terminal 102 while performing operations within the list can be identified (block 1004). Adapting operation of the application program 106 based on the user profile information can include selectively enabling (block 1006) and disabling features of the application program 106 based on the list of operations and the utilization of resources of the user terminal 102.

In this manner operations by an application program can be adapted based on observations of the user's behavior when using the application program. Such adaptation of the application program may encourage increased frequency of use, duration of use, and user satisfaction with the application program processed by the user terminal. This may provide a user terminal that operates more efficiently as application programs can be customized for a particular user, and operations for performing the application programs can be configured to optimize utilization of resources of user terminals based on that customization.

### Example User Terminal and Application Analysis Computer

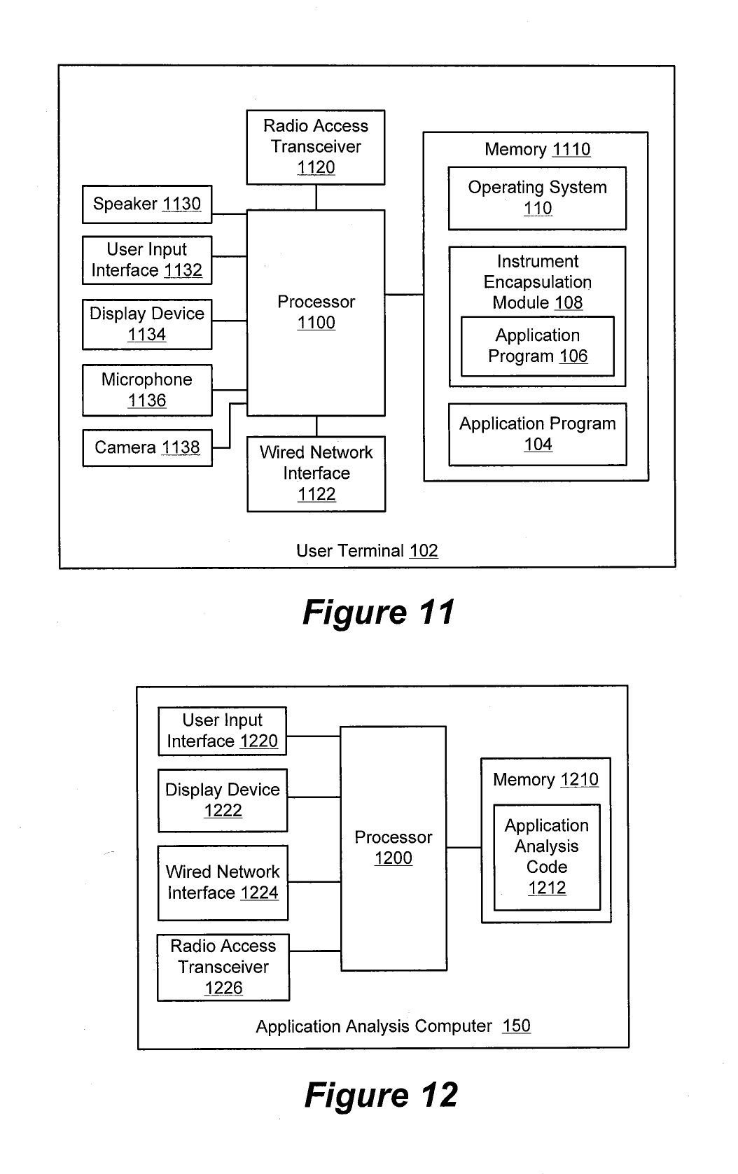

FIG. 11 is a block diagram of a user terminal 102 configured according to some embodiments of the present disclosure. Referring to FIG. 11, the mobile terminal 102 includes a processor 1100, a memory 1110, and a network interface which may include a radio access transceiver 1120 and/or a wired network interface 1122 (e.g., Ethernet interface). The radio access transceiver 1120 can include, but is not limited to, a LTE or other cellular transceiver, WLAN transceiver (IEEE 802.11), WiMax transceiver, or other radio communication transceiver configured to communicate with the application analysis computer 150 via a radio access network.

The processor 1100 may include one or more data processing circuits, such as a general purpose and/or special purpose processor, such as a microprocessor and/or digital signal processor. The processor 1100 is configured to execute computer program code in the memory 1110, described below as a non-transitory computer readable medium, to perform at least some of the operations described herein as being performed by a user terminal. The computer program code may include an operating system 110, a plurality of application programs 104 and 106, and an instrument encapsulation module 108. The instrument encapsulation module 108 when executed by the processor 1100 causes the processor 1100 to perform operations in accordance with one or more embodiments disclosed herein. The user terminal 102 may further include a speaker 1130, user input interface 1132 (e.g., touch screen, keyboard, keypad, etc.), a display device 1134, a microphone 1136, and a camera 1138. As used herein, the term “user terminal” may include a cellular radiotelephone, satellite radiotelephone, a gaming console, a smart appliance, a tablet computer, a laptop computer, and/or a desktop computer.

FIG. 12 is a block diagram of an application analysis computer 150 configured according to some embodiments of the present disclosure. The application analysis computer 150 includes a processor 1200, a memory 1210, and a network interface which may include a radio access transceiver 1226 and/or a wired network interface 1224 (e.g., Ethernet interface). The radio access transceiver 1226 can include, but is not limited to, a LTE or other cellular transceiver, WLAN transceiver (IEEE 802.11), WiMax transceiver, or other radio communication transceiver configured to communicate with the user terminal 102 via a radio access network.

The processor 1200 may include one or more data processing circuits, such as a general purpose and/or special purpose processor (e.g., microprocessor and/or digital signal processor) that may be collocated or distributed across one or more networks. The processor 1200 is configured to execute computer program code in the memory 1210, described below as a non-transitory computer readable medium, to perform at least some of the operations described herein as being performed by an application analysis computer. The computer program code may include application analysis code 1212 that when executed by the processor 1200 causes the processor 1200 to perform operations in accordance with one or more embodiments disclosed herein for the application analysis computer 150. The application analysis computer 150 may further include a user input interface 1220 (e.g., touch screen, keyboard, keypad, etc.) and a display device 1222.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A computer program product, comprising:
a tangible computer readable storage medium comprising computer readable program code embodied in the medium that when executed by a processor of a user terminal causes the processor to perform operations comprising:
generating user profile information characterizing measured user's interaction with an application program that is encapsulated by the computer readable program code and processed by the processor; and
adapting operation of the application program based on the user profile information.

2. The computer program product of claim 1, wherein the generating user profile information characterizing the measured user's interaction with the application program that is encapsulated by the computer readable program code and processed by the processor, comprises:
measuring the user's interaction with the application program based on monitoring application programming interface calls by the application program.

3. The computer program product of claim 2, wherein the measuring the user's interaction with the application program based on monitoring application programming interface calls by the application program, comprises:
measuring elapsed time between the application programming interface calls by the application program.

4. The computer program product of claim 3, wherein the adapting operation of the application program based on the user profile information, comprises:
changing user access to a defined feature of the application program from a locked state preventing processing by the processor to an unlocked state allowing processing by the processor based on the elapsed time satisfying a threshold time.

5. The computer program product of claim 2, wherein the measuring the user's interaction with the application program based on monitoring application programming interface calls by the application program, comprises:
measuring a duration of operational use of the application program by the user based on elapsed time between occurrence of one of the application programming interface calls proximate in time after start-up of the application program and occurrence of another one of the application programming interface calls proximate in time before shut-down of the application program.

6. The computer program product of claim 5, wherein the adapting operation of the application program based on the user profile information, comprises:
changing user access to a defined feature of the application program from a locked state preventing processing by the processor to an unlocked state allowing processing by the processor based on the duration of operational use not satisfying a threshold time.

7. The computer program product of claim 2, wherein the measuring the user's interaction with the application program based on monitoring application programming interface calls by the application program, comprises:
measuring responsiveness of the application program to user input control of the application program based on elapsed time between sequential occurrences of a defined type of the application programming interface calls by the application program to process user input.

8. The computer program product of claim 7, wherein the adapting operation of the application program based on the user profile information, comprises:
reporting the elapsed time between sequential occurrences of a defined type of the application programming interface calls by the application program to process user input to an application analysis computer based on the elapsed time satisfying a threshold time.

9. The computer program product of claim 2, wherein the measuring the user's interaction with the application program based on monitoring application programming interface calls by the application program, comprises:
measuring, based on the application programming interface calls, a number of unsuccessful attempts by the user to perform a feature of the application program before ceasing the attempts.

10. The computer program product of claim 9, wherein the adapting operation of the application program based on the user profile information, comprises:
reporting the number of unsuccessful attempts to an application analysis computer based on the number of unsuccessful attempts satisfying a threshold time.

11. The computer program product of claim 2, wherein the measuring the user's interaction with the application program based on monitoring application programming interface calls by the application program, comprises:
identifying, based on the application programming interface calls, a sequence of the features of the application program selected by the user that are indicative of a defined problematic use of the application program by the user.

12. The computer program product of claim 11, wherein the adapting operation of the application program based on the user profile information, comprises:
reporting the sequence of the features of the application program to an application analysis computer.

13. The computer program product of claim 2, wherein the measuring the user's interaction with the application program based on monitoring application programming interface calls by the application program, comprises:
generating a listing of application programming interface calls by the application program within a threshold time before shut-down of the application program.

14. The computer program product of claim 13, wherein the adapting operation of the application program based on the user profile information, comprises:
comparing the listing of application programming interface calls to a previous listing of application programming interface calls generated within the threshold time before a previous shut-down of the application program; and
selectively reporting the listing of application programming interface calls to an application analysis computer based on the comparing.

15. The computer program product of claim 2, wherein the measuring the user's interaction with the application program based on monitoring application programming interface calls by the application program, comprises:
generating a listing of application programming interface calls by the application program relating to communication between the application program and another application program executed by the processor of the user terminal.

16. The computer program product of claim 1, wherein
the generating user profile information characterizing the measured user's interaction with the application program that is encapsulated by the computer readable program code and processed by the processor, comprises:
generating a list of operations performed by the application program responsive to user interaction with the application program; and
generating a list of other application programs that are active in a background state while the user is interacting with the application program; and
the adapting operation of the application program based on the user profile information, comprises:
selectively enabling and disabling data communication between the application program and one of the other application programs in the list, based on the list of operations and the list of other application programs.

17. The computer program product of claim 1, wherein
the generating user profile information characterizing the measured user's interaction with the application program that is encapsulated by the computer readable program code and processed by the processor, comprises:
generating a list of operations performed by the application program responsive to user interaction with the application program; and
identifying a geographic region in which the user terminal is located; and
the adapting operation of the application program based on the user profile information, comprises:
selectively enabling and disabling features of the application program based on the list of operations and the geographic region.

18. The computer program product of claim 1, wherein
the generating user profile information characterizing the measured user's interaction with the application program that is encapsulated by the computer readable program code and processed by the processor, comprises:
generating a list of operations performed by the application program responsive to user interaction with the application program; and
identifying utilization of resources of the user terminal while performed the operations within the list; and
the adapting operation of the application program based on the user profile information, comprises:
selectively enabling and disabling features of the application program based on the list of operations and the utilization of resources of the user terminal.

19. The computer program product of claim 1, wherein
the generating user profile information characterizing the measured user's interaction with the application program that is encapsulated by the computer readable program code and processed by the processor, comprises:
obtaining a digital picture of the user from a camera of the user terminal;
generating a list of operations performed by the application program responsive to user interaction with the application program; and
communicating the digital picture and the listing of operations performed by the application program from the user terminal to an application analysis computer to generate the user profile information that characterizes the measured user's interaction with the application program; and
the adapting operation of the application program based on the user profile information, comprises:
receiving a command from the application analysis computer; and
selectively enabling and disabling features of the application program based on the command.

20. The computer program product of claim 1, wherein
the generating user profile information characterizing the measured user's interaction with the application program that is encapsulated by the computer readable program code and processed by the processor, comprises:
obtaining a digital voice sample of the user from a microphone of the user terminal;
generating a list of operations performed by the application program responsive to user interaction with the application program; and
communicating the digital voice sample and the listing of operations performed by the application program from the user terminal to an application analysis computer to generate the user profile information that characterizes the measured user's interaction with the application program; and
the adapting operation of the application program based on the user profile information, comprises:
receiving a command from the application analysis computer; and
selectively enabling and disabling features of the application program based on the command.
